(19) United States
(12) Patent Application Publication
(10) Pub. No.: US 2003/0146262 A1
(43) Pub. Date: Aug. 7, 2003

(54) Fastener positioning apparatus for a fastener driving tool

(75) Inventors: Shin-Leei Hwang, Cincinnati, OH (US); Donald Carl Ries, Loveland, OH (US); John Peter Schloemer, Cincinnati, OH (US)

Correspondence Address: FROST BROWN TODD LLC, 2200 PNC Center, 201 E. Fifth Street, Cincinnati, OH, 45202-4182, US

(73) Assignee: Senco Products, Inc.

(21) Appl. No.: 10/357,061

(22) Filed: Feb. 3, 2003

Related U.S. Application Data
(60) Provisional application No. 60/355,006, filed on Feb. 7, 2002.

(51) Int. Cl. B25C 5/02

(52) U.S. Cl. 227/113

(57) ABSTRACT

The invention disclosed and taught herein relates to a powered fastener driving tool particularly suited for driving straight line fasteners, such as nails or straight line pins into a work piece. A hand held fastener driving tool as particularly described herein, may be used to drive straight line pins, nails and/or staples into a work piece. A magnet is placed within the fastener driving head that magnetically attracts the lead fastener of a soldier course strip of fasteners thereby securing the lead fastener, and trailing strip of fasteners, within the driving tool thereby preventing the possibility of the tool jamming by a fastener not aligning horizontal within the tool and/or its supply magazine.

### RELATED PATENT APPLICATIONS

This application claims the priority of U.S. Provisional Patent Application serial No. 60/355,006 filed on Feb. 7, 2002.

### BACKGROUND

The present invention generally relates to a hand held, pneumatically operated fastener driving tool particularly suited for driving straight line fasteners, such as nails or straight line pins into a work piece. A hand held fastener driving tool, as further described herein below, used to drive straight line pins or staples typically drives 23 gauge wire fasteners ranging in length from ½″ to 1″. The tool is typically loaded by turning it upside down, opening the fastener supply magazine, inserting a strip of “soldier course” fasteners into the magazine and closing the magazine. During operation of the tool, two problems are frequently experienced:

1) The pin fasteners , which have a very small cross-section, may not position themselves properly within the tool's driving track. This may result in the driver being unable to pick the fastener off the soldier course strip of fasteners during the fastener driving operation The end result is a fastener jam or no fastener being driven causing malfunction of the tool.

2) When loading an additional strip of soldier course fasteners into the tool magazine the tool is again turned upside down and the magazine opened for refilling with an additional strip of soldier course fasteners. Typically, the previously loaded strip of fasteners has not been completely used thereby leaving a short strip having a small number of fasteners within the magazine. When all of the previously loaded fasteners are not entirely driven out of the magazine, the short strip of fasteners remaining in the magazine, may fall over on their side. Thus the short strip of remaining fasteners may become jammed in the magazine with the feeder shoe or lodged in the height adjusting mechanism. This will very likely require disassembly of the tool magazine to remove the jammed fasteners.

### BRIEF SUMMARY OF THE INVENTION

By our invention the problems identified above are overcome by providing a magnet within the face plate of the fastener driving tool's driving head assembly whereby the lead fastener, in the soldier course fastener strip, is magnetically attracted to and held against the face plate and aligned with the fastener driving rod. Thus when the fastener supply magazine is opened for replacement of additional fastener strips, the fasteners remaining within the fastener supply magazine are held in place by action of the magnetic field acting upon the remaining fasteners.

### BRIEF DESCRIPTION OF THE DRAWINGS

FIG. 1 presents a side elevational view of a typical hand tool, embodying the present invention, for driving soldier course fasteners into a work piece not shown

FIG. 2 presents an exploded pictorial of the fastener supply magazine and guide plates for the hand tool illustrated in FIG. 1.

FIG. 3 presents an exploded pictorial view of the fastener guide plates embodying the present invention.

FIG. 4 presents a crossectional view taken along line 4-4 in FIG. 1.

FIG. 5 presents a crossectional view taken along line 5-5 in FIG. 4.

FIG. 6 presents a crossectional view taken along line 6-6 in FIG. 1.

### DETAILED DESCRIPTION OF THE INVENTION

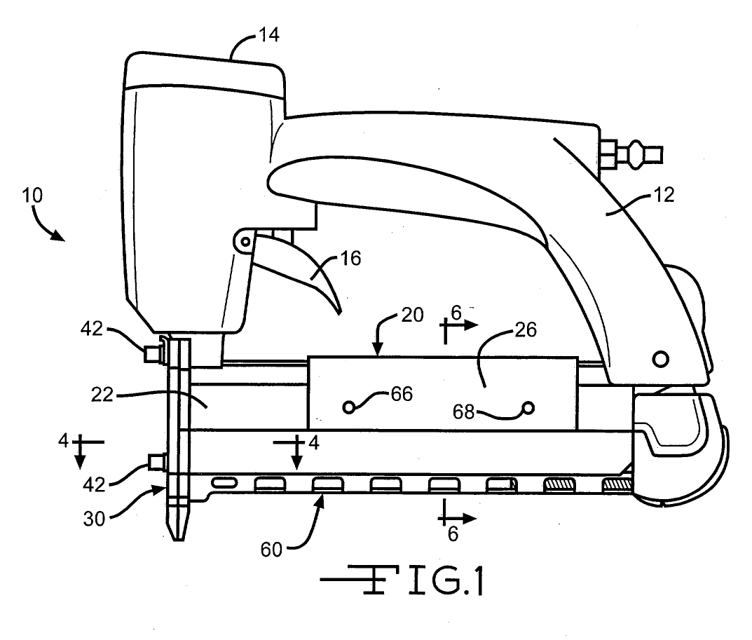

FIG. 1 illustrates a typical, compressed air powered, hand tool 10 for applying nail like fasteners from a soldier course strip such as nails and/or straight line staples. Hand tool 10 basically comprises a handle 12, power head 14, a trigger 16 for activating the tool and a fastener supply magazine assembly 20.

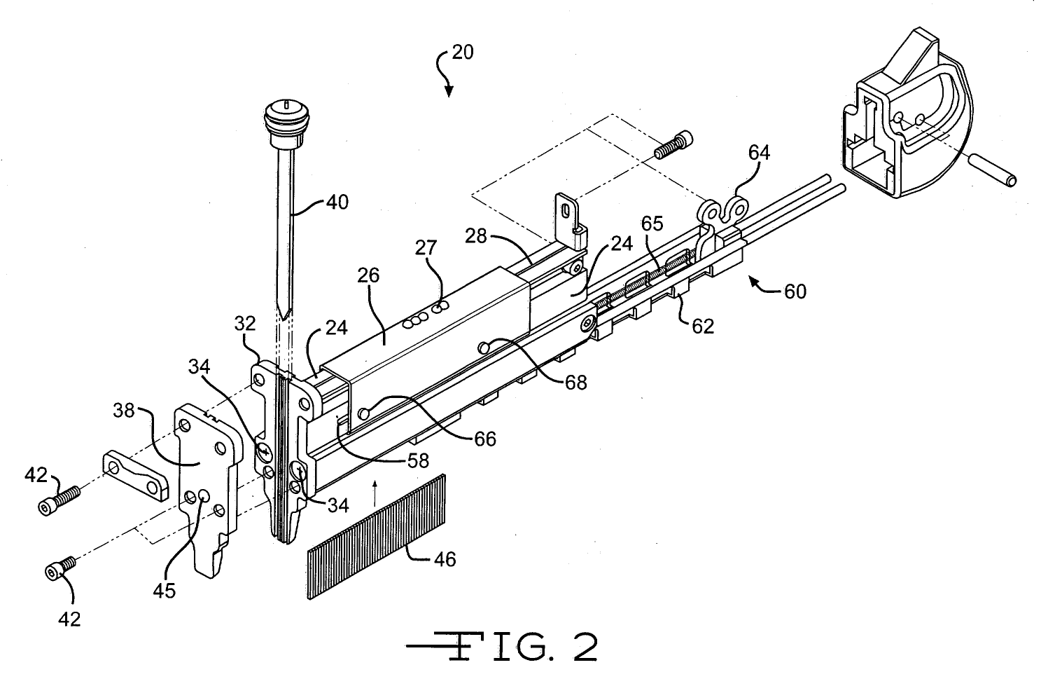

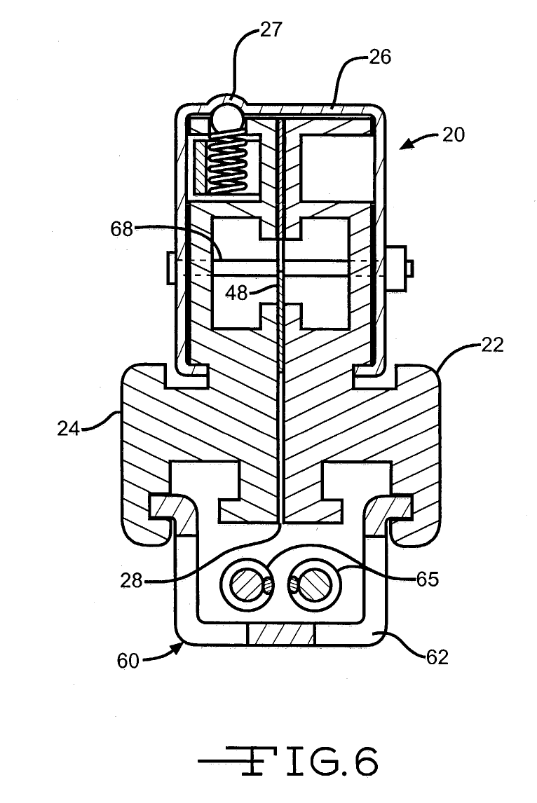

As illustrated in FIGS. 2 and 6, fastener supply magazine assembly 20 typically comprises a left and right parallel guide rails 22 and 24 forming a fastener guide channel 28, for receiving therein a “soldier-course” strip of fasteners 46. Positioned above fastener strip 46, within guide channel 28, is a fastener length adjustment plate 48 which adjusts the depth of guide channel 28 in accord with various fastener lengths. Positioned atop and astride parallel guide rails 22 and 24 is an overriding U shaped fastener length, adjusting slide 26.

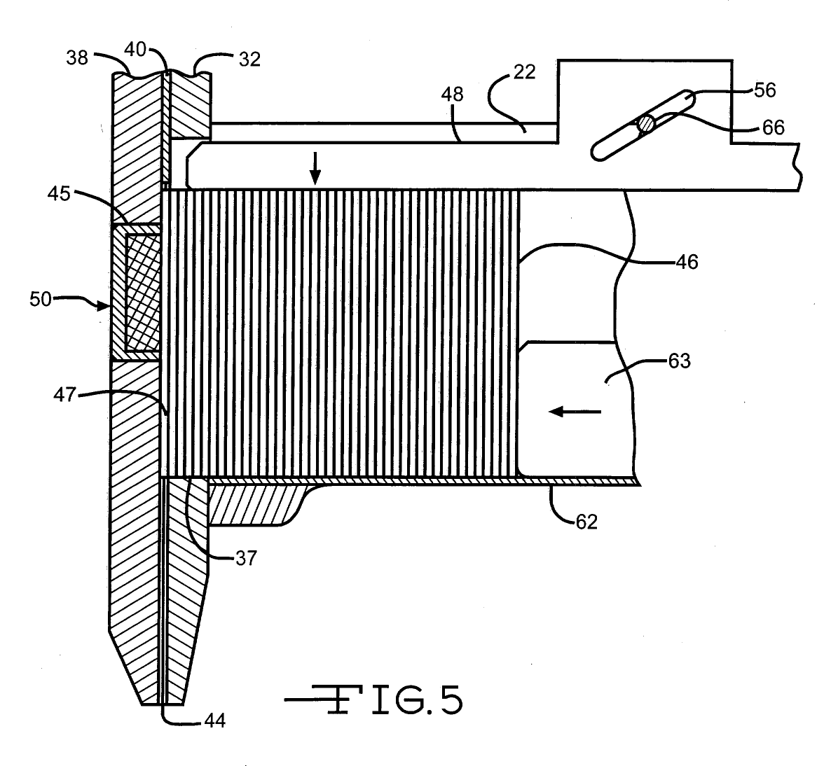

Referring to FIG. 5, adjustment plate 48 includes a forward and rearward angular slot, of which only the forward slot 56 is illustrated. The rearward angular slot (not shown) is positioned further rearward from forward slot 56. A pair of opposing horizontal slots are provided in guide rails 22 and 24, of which only the left front slot 58 is visible in FIG. 2. Laterally extending pins 66 and 68 extend laterally through slide 26, the horizontal slots in guide rails 22 and 24 and through the angular slots in length adjustment plate 48 as illustrated in FIG. 6. As slide 26 is moved forward and rearward, length adjustment plate 48 rises and/or lowers within guide channel 28 thereby adjusting the depth of channel 28 for various length fasteners. A series of hemispherical detents 27 are longitudinally positioned whereby the tool operator may select the proper position of fastener length adjustment plate 48 for various fastener lengths.

Slidingly attached and forming the bottom of fastener supply magazine assembly 20 is bottom assembly 60, see FIG. 6. Bottom assembly 60 typically comprises bottom frame 62 having therein a pair of compression springs 65 and spring loaded feeder shoe 63 which typically biases fastener strip 46 towards the driving head 30 of tool 10. When it is desired to add an additional fastener strip 46 to tool 10, bottom frame 62 is unlocked from supply magazine 20, by action of latching mechanism 64, and withdrawn longitudinally from magazine 20 thereby providing access to fastener guide channel 28 for replacement of a fastener strip 46. Once a replacement fastener strip is inserted into guide channel 28, bottom assembly 60 is reinserted into magazine assembly 20 whereby fastener strip 46 is urged forward toward driving head assembly 30 by action of compression springs 65 upon feeder shoe 63.

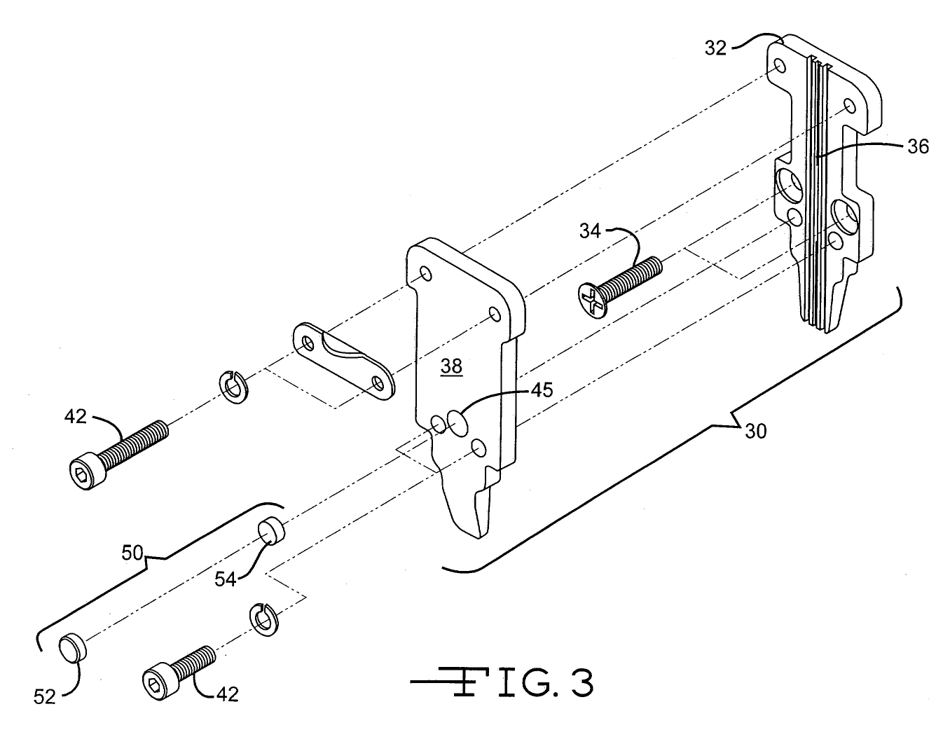

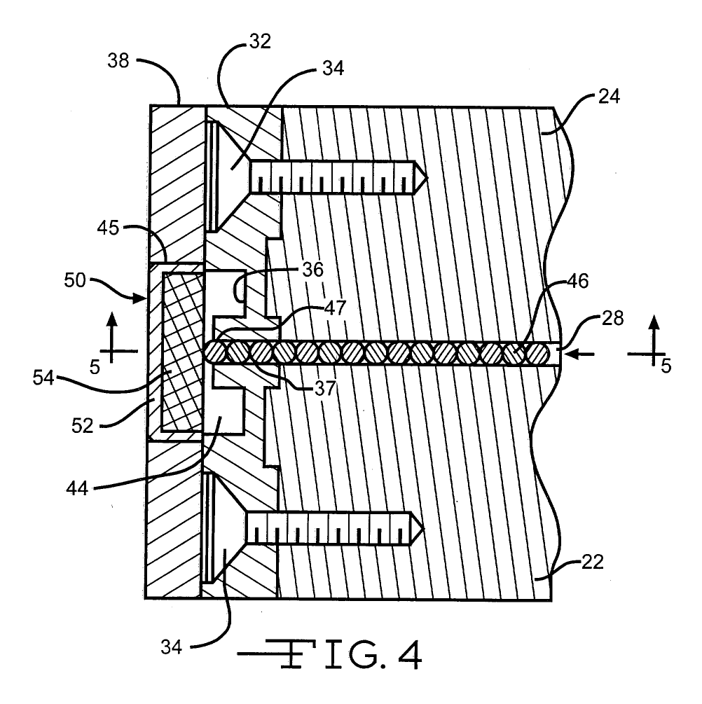

As illustrated in FIG. 3, the fastener driving head assembly 30 comprises driver plate 32 affixed to guide rails 22 and 24 by typical threaded fasteners 34. Driver plate 32 includes a vertically cut guide channel 36 for slidingly receiving driving rod 40 therein. A matching face plate 38 is attached to driver plate 32 by four threaded fasteners 42 thereby forming driver channel 44 therebetween as illustrated in FIG. 4. Driver plate 32 is provided with a vertical slot like opening 37 for the passage of fastener strip 46 to pass therethrough.

Face plate 38 includes an opening or aperture 45 positioned upon the vertical centerline of face plate 38 such that aperture 45 is opposite the soldier course fastener clip 46 as illustrated in FIGS. 4 and 5. Positioned within aperture 45, and affixed thereto, is magnet assembly 50 comprising a magnet holding cup 52 having therein magnet 54 as best illustrated in FIG. 4.

In operation, as the fastener strip, and the lead fastener 47 approach face plate 38, the magnetic field of magnet 54 attracts and draws the lead fastener 47 toward and against face plate 38. Thus as the number of fasteners in clip 46 decreases to small number approaching and equaling one, the fasteners will not fall, horizontally into channel 44 between fastener guides 22 and 24 when fastener supply magazine 20 is opened for insertion of an additional fastener strip. To the contrary, when fastener supply magazine is opened for adding an additional fastener strip, magnet 54 will, by the magnetic force acting upon lead fastener 47, hold the small amount of unused fasteners in their operational position thereby preventing the remaining, unused fasteners from falling, horizontally, into guide channel 44 wherein they may cause a “jammed” fastener supply magazine.

Although a compression spring 65 biased feeder plate 63 may be used to advance strip 46 as the lead fasteners are driven into the work piece, the magnetic force acting upon the fastener strip 46, by magnet 54, may be sufficient to advance strip 46 as the lead fastener is drivingly removed from strip 46 thereby eliminating the need for compression spring 65.

While we have described above the principles of our invention in connection with a particular embodiment, it is to be clearly understood that this description is made only by way of example and not as a limitation of the scope of our invention as set forth in the accompanying claims.

We claim:

1. In a machine for applying metal fasteners to a work piece wherein said fasteners are supplied to said machine's fastener driving mechanism in an elongate strip of single fasteners tandemly and removably attached to one another thereby forming said strip, said strip of fasteners conveyed to said machine's driving mechanism within at least one elongated slot whereby said fasteners are presented, one at a time, to a fastener driving driver which singly drives said fasteners into said work piece, the improvement comprising a magnet selectively positioned for attracting the leading end fastener, and the series of fasteners tandemly following therebehind, whereby said leading end fastener is magnetically held in position for being struck by said driver thereby driving said leading end fastener into said work piece.

2. A hand held fastener driving tool for driving fasteners into a work piece comprising:
a) a power head for providing the necessary striking force for driving said fasteners into said work piece,
b) a handle attached to said power head for holding said tool in its operational position with respect to said work piece,
c) a fastener supply magazine having a first end attached to the free end of said handle and a second end attached to said power head,
d) a driver plate attached to the second end of said fastener supply magazine, said driver plate having vertical guide means therein for slidingly receiving a fastener driving driver therein, said fastener driver being driven by said power head, said driver plate having an opening therein whereby said fasteners may pass therethrough and become aligned with said fastener driver for being driven into said work piece,
e) a face plate attached to said driver plate whereby said face plate and said vertical guide means, in said driver plate, cooperate to form a conduit through which said fastener driver operationally reciprocates as said fastener driver drives said fasteners through said conduit and into said work piece,
f) a magnet positioned within said face plate whereby the magnetic field of said magnet draws said fastener thereagainst and in alignment with said fastener driver prior to being driven into said work piece by said fastener driver.

3. A hand held fastener driving tool for driving straight line fasteners into a work piece comprising:
a) a power head for providing the necessary striking force for driving said fasteners into said work piece,
b) a handle attached to said power head for holding said tool in its operational position with respect to said work piece,
c) a fastener supply magazine having a first end attached to the free end of said handle and a second end attached to said power head,
d) a driver plate attached to the second end of said fastener supply magazine, said driver plate having at least one U shaped vertical guide channel therein for slidingly receiving a fastener driving driver therein, said fastener driver being driven by said power head, said driver plate having a vertical elongated opening therein whereby said fasteners may pass therethrough and become aligned with said fastener driver before being driven into said work piece,
e) a face plate attached to said driver plate whereby said face plate and said vertical guide channel, in said driver plate, cooperate to form a conduit through which said fastener driver operationally reciprocates as said fastener driver drives said fasteners into said work piece,
f) a magnet positioned within said face plate whereby the magnetic field of said magnet draws said fastener thereagainst and in alignment with said fastener driver prior to being driven into said work piece by said fastener driver.

4. A hand held fastener driving tool for driving straight line fasteners into a work piece said tool comprising:
a) a power head for providing the necessary striking force for driving said fasteners into said work piece,
b) a handle for holding said tool in its operational position with respect to said work piece, said handle having a first and second end, said first end attached to said power head,
c) a fastener supply magazine having a first and second end thereof, said first end of said supply magazine attached to the second end of said handle and said second end of said supply magazine attached to said power head, said fastener supply magazine including a pair of parallel guide rails forming a slot therebetween for receiving a soldier-course strip of said straight line fasteners therein,
d) a driver plate attached to the second end of said fastener supply magazine, said driver plate having at least one U shaped vertical guide channel therein for slidingly receiving a fastener driving driver therein, said fastener driver being driven by said power head, said driver plate having a vertical elongated opening therein, aligned with the slot between said parallel guide rails, whereby said fastener strip may pass therethrough whereby the leading fastener of said fastener strip may become aligned with said fastener driver,
e) a face plate attached to said driver plate whereby said face plate and said vertical guide channel, in said driver plate, cooperate to form a conduit through which said fastener driver operationally reciprocates as said fastener driver drives said fasteners into said work piece,
f) an aperture within said face plate aligned with said vertical elongated opening within said driver plate,
g) a magnet positioned within said aperture of said face plate whereby the magnetic field of said magnet draws the lead fastener of said fastener strip against said face plate and into vertical alignment with said fastener driver prior to being driven into said work piece by said fastener driver.

5. A fastener driving tool for driving fasteners into a work piece comprising:
a) a magazine for supplying a soldier course strip of said fasteners,
b) a driving head attached to the end of said magazine, said driving head having an opening therein whereby said strip of fasteners may pass from said magazine into said driving head,
c) a magnet, positioned within said driving head, opposite said opening whereby the lead fastener of said strip is drawn against said magnet,
d) a staple driving rod slidably positioned within said driving head for reciprocal motion with respect to said magazine, said driving rod reciprocating through a forward and a reverse stroke whereby said driving rod, upon its forward stroke, strips said lead fastener from said strip of fasteners thereby driving said fastener into said work piece.

6. The fasteners driving tool as claimed in claim 5 wherein said strip of fasteners comprise wire staples.

7. The fasteners driving tool as claimed in claim 6 wherein said strip of fasteners comprise straight-line staples.

8. In a fastener driving tool for driving fasteners into a work piece comprising:
a) a magazine for supplying a soldier course strip of said fasteners,
b) a driving head attached to the end of said magazine, said driving head having an opening therein whereby said strip of fasteners may pass from said magazine into said driving head,
c) a staple driving rod slidably positioned within said driving head for reciprocal motion with respect to said magazine, said driving rod reciprocating through a forward and a reverse stroke whereby said driving rod, upon its forward stroke, strips said lead fastener from said strip of fasteners thereby driving said fastener into said work piece,
the improvement comprising a magnet positioned within said driving head, opposite said opening, whereby the lead fastener of said fastener strip is drawn against said magnet prior to being driven into said work piece.
